(19) United States
(12) Patent Application Publication
(10) Pub. No.: US 2004/0024874 A1
(43) Pub. Date: Feb. 5, 2004

(54) Processor with load balancing

(76) Inventor: Neale Bremner Smith, Northumberland (GB)

Correspondence Address: SALTAMAR INNOVATIONS, 30 FERN LANE, SOUTH PORTLAND, ME, 04106, US

(21) Appl. No.: 10/276,636

(22) PCT Filed: May 18, 2001
(86) PCT No.: PCT/GB01/02170

(30) Foreign Application Priority Data
May 19, 2000 (GB) 0011974.3

(51) Int. Cl. G06F 15/173

(52) U.S. Cl. 709/225; 718/105

(57) ABSTRACT

The present invention relates to a system and method of distributing workload among processors (11) in a multi-processor system (10), with workload being transferred through a plurality of transfers between processor pairs (12), such that the plurality of pairs together define a closed loop. The present invention enables a processor to automatically balance its workload with other similar processors connected to it, with minimal interprocessor connection.

The present invention relates to a system intended for use in multi-processor computers and in particular to work load balancing in dataflow parallel computers.

Multi-processor computers are used to execute programs that can utilise parallelism, with concurrent work being distributed across the processors to improve execution speeds.

The dataflow model is convenient for parallel execution, having execution of an instruction either on data availability or on data demand, not because it is the next instruction in a list. This also implies that the order of execution of operations is irrelevant, indeterminate and cannot be relied upon. The dataflow model is also convenient for parallel execution because tokens may flow to specified instructions rather than having the data stored in a register or memory potentially accessible by all other instructions.

In multithreaded dataflow, memory may be introduced into the flow of tokens to instructions. Only one token is required to trigger execution of an instruction, the second operand being fetched from the memory when the instruction is issued or executed (Coleman, J. N.; A High Speed Dataflow Processing Element and Its Performance Compared to a von Neumann Mainframe, Proc. 7^{th} IEEE International Parallel Processing Symposium, California, pp.24-33, 1993 and Papadopoulos, G. M.; Traub, K. R.; Multithreading: A Revisionist View of Dataflow Architectures, Ann. Int. Symp. Comp. Arch., pp.342-351, 1991). The result is passed along an arc to initiate a new instruction and optionally written back to memory. The memory makes it difficult to avoid side-effects in hardware, but their problems can be avoided in software through suitable programming discipline. This modification of the dataflow model overcomes some of the physical and speed difficulties of other solutions. In particular it removes the need for hardware token matching. As the smallest element that can be parallelised is a thread, rather than an instruction, the number of times that the token matching need be performed is much reduced and so the overheads incurred in performing the operation in software can be justified.

Load balancing in a multi-processor computer has the aim of ensuring every processor performs an equal amount of work. This is important for maximising computational speeds. Traditionally, multi-processor computers have required complicated hardware or software to perform this task, and the configuration (i.e., interconnection) of the processors and memories need to be taken into account. The load balancing mechanism has greatest performance restricting effect during times of explosive parallelism. It must be able to transfer loads throughout the system quickly, in order to maintain a higher overall efficiency.

Traditional methods of load balancing require expensive networks and complicated load analysis, and static off-line scheduling has been used to solve the problem (this entails analysing the program before it is run to find out what resources it needs, when, and scheduling all tasks prior to running).

On-line load balancing is difficult because of the complexity and cost in the networks involved. For example, in a system containing 100 processors, load balancing potentially requires not only a check of all 100 processors to find out which are free to do work, but also consideration of which piece of work is best suited to each processor, depending on what is already scheduled for that processor. If pieces of work differ in size then care must be taken to ensure that work is evenly distributed.

The difficulty in balancing load is proportional to the square of the number of processors. If it is decided that all work must be scheduled within a fixed amount time, even under the worst case conditions, then because work can originate anywhere and be scheduled to any destination, it is necessary to have a network with a band width proportional to N² where N is the number of processors. This means that a system with one thousand processors is ten thousand times more complicated and costly than a system with only ten processors, despite having only one hundred times the power. It is desirable to have a system where complexity and cost are proportional only to N, even under worst case conditions.

In the prior art inventions are known which provide systems for load balancing in multi-processor computer systems. U.S. Pat. No. 5,630,129 to Sandia Corporation describes an application level method for dynamically maintaining global load balance on a parallel computer. Global load balancing is achieved by overlapping neighbourhoods of processors, where each neighbourhood performs local load balancing.

U.S. Pat. No. 5,701,482 to Hughes Aircraft Company describes a modular array processor architecture with a control bus used to keep track of available resources throughout the architecture under control of a scheduling algorithm that reallocates tasks to available processors based on a set of heuristic rules to achieve the load balancing.

U.S. Pat. No. 5,898,870 to Hitachi, Ltd. describes a load sharing method of a parallel computer system which sets resource utilisation target values by work for the computers in a computer group. Newly requested work processes are allocated to computers in the computer group on the basis of the differences between the resource utilisation target parameter values and current values of a parameter indicating the resource utilisation.

It is an object of the present invention to provide a processor which can automatically balance its workload with other similar processors connected to it.

According to the first aspect of this invention, there is provided a multi-processor system comprising a plurality of processors, a plurality of comparison means for comparing the load at a pair of processors and a plurality of load balancing means responsive to the comparison means for passing workload between the said pair of processors, characterised in that the plurality of load balancing means defines a closed loop around which workload can be passed.

Preferably the passing of workload is uni-directional around the closed loop.

More preferably, the passing of workload comprises the passing of a processing thread.

Preferably the passing of a processor thread comprises the passing of an instruction.

Preferably the passing of an instruction comprises the passing of an instruction and the pointer to the context of said instruction.

According to a second aspect of this invention, there is provide a method of distributing load among processors in a multi-processor system. The method comprising the steps of:

comparing the load in pairs of processors and

transferring workload between said processors characterised in that the workload is transferred through a plurality of transfers between pairs, such that the plurality of pairs together define a closed loop.

Preferably, the pairs in the closed loop comprising a first processor and a second processor, the first processor informs the second processor of the first processor's workload.

Preferably, the second processor compares the first processor's workload with its own workload.

More preferably, the second processor determines whether it will request more work from the first processor.

Preferably, the second processor requests work from the first processor.

Optionally, comparison means for comparing the load of two processors and load balancing means responsive to the comparison means can be introduced cutting across the loop to accelerate load balancing around the loop.

The load balancing means responsive to the comparison means ensure that between every pair there is a balance of workload, and a closed loop ensures that every processor in every pair is downstream of another processor, which in turn ensures that the entire loop is inherently balanced with respect to workload.

With a bi-directional link between the first and second processor, both processors in a pair inform each other of workload and request work as appropriate. There is no requirement for such pairs to be arranged in a circle.

When work is requested from a processor, preferably that processor picks up a suitable instruction out of its pipeline, and transfers that instruction and its context (e.g., data tokens on input/output arcs) across to the requesting processor which then inserts it directly into its own pipeline. This is possible because each instruction is an independent unit of work within each processor, and therefore within the system as a whole.

In order to provide a better understanding of the present invention an example will now be described, by way of example only, and with reference to the accompanying Figures, in which:

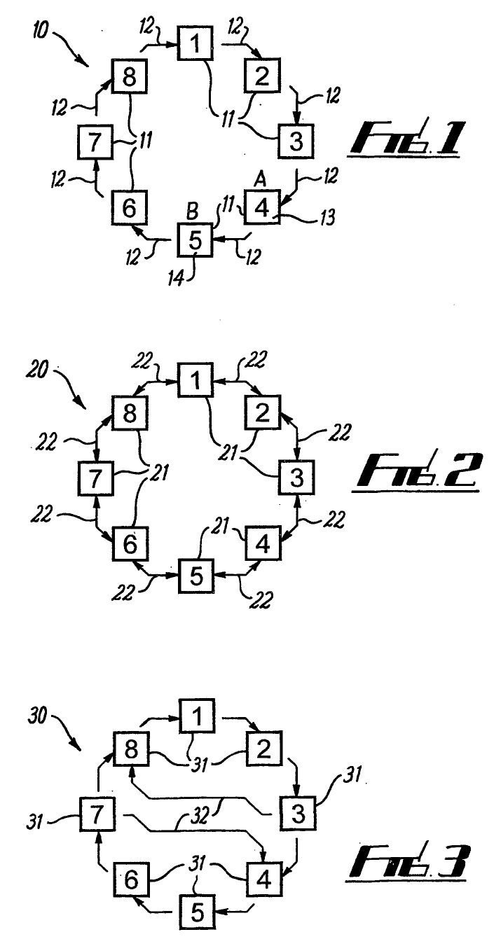

FIGS. 1 to 3 illustrate configurations of the processors and workflow in the system of the present invention

FIG. 4 illustrates a block diagram of the system including processors and memory

FIG. 5 illustrates thread transfer between a pair of processors

The invention is a multi-processor dataflow computer which functions to balance workload between the processors.

Although the embodiments of the invention described with reference to the drawings comprise computer apparatus and processes performed in computer apparatus, the invention also extends to computer programs, particularly computer programs on or in a carrier, adapted for putting the invention into practice. The program may be in the form of source code, object code, a code of intermediate source and object code such as in partially compiled form suitable for use in the implementation of the processes according to the invention. The carrier may be any entity or device capable of carrying the program.

For example, the carrier may comprise a storage medium, such as ROM, for example a CD ROM or a semiconductor ROM, or a magnetic recording medium, for example, floppy disc or hard disc. Further, the carrier may be a transmissible carrier such as an electrical or optical signal which may be conveyed via electrical or optical cable or by radio or other means.

When the program is embodied in a signal which may be conveyed directly by a cable or other device or means, the carrier may be constituted by such cable or other device or means.

Alternatively, the carrier may be an integrated circuit in which the program is embedded, the integrated circuit being adapted for performing, or for use in the performance of, the relevant processes.

Referring firstly to FIG. 1, a closed loop 10 of processors 11 are connected by link means 12. Preferably the link means comprises connection though an electrical circuit or a packet switched network. The link means provide the means for comparison of workload and passing of workload between processors. In FIG. 1 the link means 10 are uni-directional, wherein the transfer of workload through the link means is in one direction. With a uni-directional link from processor A 13 (“upstream”) to processor B 14 (“downstream”), A informs B of how much workload it has, B then compares this with its own level of workload, and if B is less loaded than A, then it requests work from A. It is therefore ensured that B has at least as much work as A. Such pairs are linked end to end in a chain, with all the links going in the same direction, with the ends of the chain joined together. This forms a closed loop with all the workload transfers travelling in the same direction. Since in each pair the one downstream of the link has at least as much work as the one upstream, and every processor in every pair downstream of another processor, it ensures that the entire ring is inherently balanced.

Referring to FIG. 2, a closed loop 20 of processors 21 with bi-directional link means 22 is shown, wherein the transfer of workload through the link means between each processor pair is in one direction. The two processors in a pair both inform each other and request workload as appropriate.

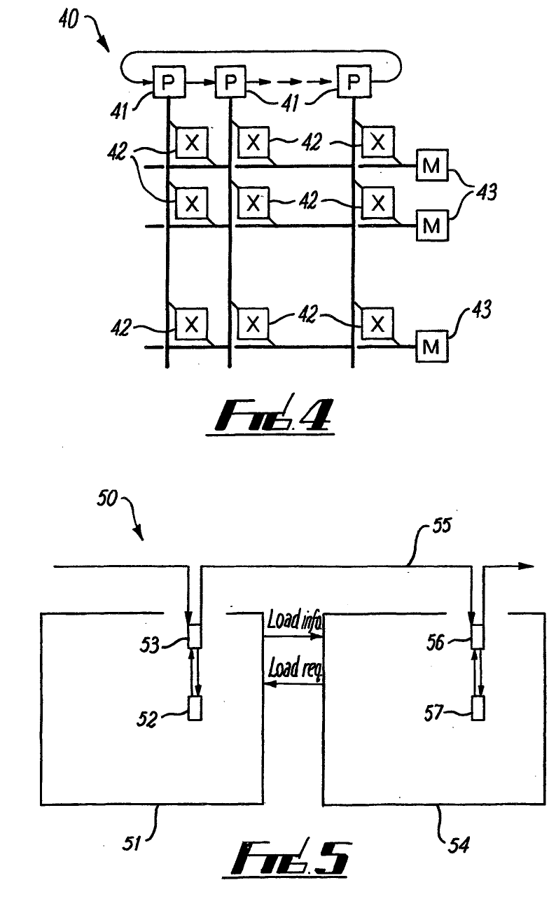

Referring to FIG. 3, a closed loop 30 of processors 31 is shown with additional links 32 between pairs cutting across the ring, which have been introduced to accelerate load balancing around the ring.

Referring to FIG. 4, a block diagram of a multi-processor system 40 is shown, which is a shared memory multi-processor dataflow computer. The three main components are processors 41, crossbar switches 42 for providing the means for relaying memory requests from processors to memory controllers, and memory controllers 43. We envisage these component being implemented on separate chips and connected accordingly. Preferably, the processors are connected in a uni-directional circular pipeline or closed loop, and access is set as interleaved memory modules through a crossbar switch array. Preferably processors issue memory requests to the crossbar switches, which then relay them to the memory leaves. Memory controllers return the result of the request back to the processors via the crossbar switches. Preferably all communication is handled automatically in hardware. Preferably, inter-processor communication is invisible to the programmer and program and preferably comprises load balancing traffic. Transactions allow several memory accesses to be performed concurrently; the processor can send out a stream of requests, those that go back to different crossbar switches will be handled simultaneously, and the results will stream back. This reduces rather than just hides the memory latency, but it is dependent on all memory leaves being evenly utilised.

Each processor keeps track of how many threads it is hosting at any one time. It passes this information on to the next processor round the closed loop. This means that each processor can determine its own load, as well as the load of its predecessor. By comparing the two loads, a load imbalance can be calculated. If this is outside tolerances (e.g., greater than one thread difference), then the processor may request load from its predecessor.

Referring to FIG. 5, a thread transfer between a pair of processors 50 is shown. Upon receiving a request for a load, preferably a processor's 51 multiplexer stage 52 will pick out the next passing eligible instruction and route it out of the input/output unit, IO unit 53. Preferably, the IO unit 53 comprises a shift register which transfers the instruction and its flow operands out to the requesting processor 54 over a thread transfer bus 55. Preferably, the requesting processor 54 accumulates the transmission in its own IO unit 56 and, when this shift register is full, the register contents are passed to the multiplexer 57, which then merges it into the pipeline flow. Preferably, this activity is entirely invisible to the program.

Further modification and improvements may be added without departing from the scope of the invention herein described.

1. A multi-processor system comprising a plurality of processors, a plurality of comparison means for comparing the load at a pair of processors, and a plurality of load balancing means responsive to the comparison means for passing workload between said pair of processors, characterised in that the plurality of load balancing means defines a closed loop around which workload can be passed.

2. A system as claimed in claim 1 wherein the passing of workload is uni-directional around the closed loop.

3. A system as claimed in claims 1 to 2 wherein the passing of workload comprises the passing of a processing thread.

4. A system as claimed in claim 3 wherein the passing of a processing thread comprises the passing of an instruction.

5. A system as claimed in claim 4 wherein the passing of an instruction comprises the passing of an instruction and a pointer to the context of said instruction.

6. A system as claimed in claims 1 to 5 wherein there are load balancing means responsive to comparison means comparing the load of a pair of processors in the closed loop of claim 1, the said pair of processors not being compared in claim 1.

7. A method for distributing load among processors in a multi-processor system, the method comprising the steps of:
Comparing the load in pairs of processors and
Transferring work load between said processors
characterised in that the workload is transferred through a plurality of transfers between pairs of processors, such that the plurality of pairs together define a closed loop.

8. A method as claimed in claim 7 wherein the pairs comprise a first processor and a second processor, and first processor informs the second processor of the first processor's work load.

9. A method as claimed in claim 8 wherein the second processor compares the first processor's work load with its own work load.

10. A method as claimed in claims 8 to 9 wherein the second processor determines whether it will request more work from the first processor.

11. A method as claimed in claims 8 to 10 wherein the second processor requests work from the first processor.
